(19) United States
(12) Patent Application Publication
(10) Pub. No.: US 2003/0133692 A1
(43) Pub. Date: Jul. 17, 2003

(54) VIDEO DISTRIBUTION SYSTEM

(76) Inventor: CHARLES ERIC HUNTER, HILTON HEAD ISLAND, SC (US)

Correspondence Address: Finnegan, Henderson Farabow, Garrett & Dunner LLP, 1300 I Street, N.W., Washington, DC, 20005-3315, US

(21) Appl. No.: 09/436,281

(22) Filed: Nov. 8, 1999

Related U.S. Application Data
(63) Continuation of application No. 09/385,671, filed on Aug. 27, 1999.

(51) Int. Cl. H04N 7/16; H04N 9/79; H04N 5/91; H04N 7/00; H04N 7/173

(52) U.S. Cl. 386/35; 386/46; 725/133; 725/1

(57) ABSTRACT

The invention relates to video distribution systems and, more particularly, to a system that blanket transmits video/audio content such as movies (for example, via satellite downlink transmission) to each customer's computer-based recording, storage and playback system. Customers preselect from a list of available movies or other content in advance using an interactive screen selector, and pay for only the video/audio content that is actually viewed.

### CROSS REFERENCE TO RELATED APPLICATION

This application is a continuation in part of Ser. No. 09/385,671, filed Aug. 27, 1999.

### FIELD OF THE INVENTION

The invention relates to video distribution systems and, more particularly, to a system that blanket transmits video/audio content such as movies (for example, via satellite downlink transmission) to each customer's computer-based recording, storage and playback system. Customers preselect from a list of available movies or other content in advance using an interactive screen selector, and pay for only the video/audio content that is actually viewed.

### DESCRIPTION OF THE PRIOR ART

Widespread home television viewing began in approximately 1950 with broadcast networks transmitting shows on specific, prepublished schedules. This model remained the primary model for television viewing for over thirty years.

Cable, and later direct broadcast satellite, increased the number of channels. But viewers were still subject to programming schedules.

Video cassette recorders offered the prospect of shifting viewing times, provided the end user was one of the thirty percent or less of VCR owners who learned to program their VCR's. Even among those who learned to program their VCR, time shifting via VCR remains subject to properly setting up the timer, assuring the power is in the correct state, assuring that a correct tape is in the VCR, that the tape is not full, that the tape is properly rewound, etc. Thus, for the majority of TV viewers, even at the turn of the century, the TV viewing model has scarcely changed from the mode of 1950.

Video rental stores have provided a sort of “video on demand” subject, of course, to the high cost of video cassette purchases by the rental stores, as well as the high capital outlay for real estate (land and building) and the cost of labor at the stores. Even when a title becomes available through video release, the viewer's ability to watch the show at his chosen time is subject to availability of the video at the store, round-trip transportation to the store and the inevitable problems with late returns, damaged videos, lost videos, etc.

True video-on-demand has been envisioned whereby massive video servers would be positioned in every geographic location to transfer high speed video data streams to the houses of individual viewers at any time a viewer wished to access a particular movie or other content. However, this type of video demand system, after years and billions of dollars of investment, has proven to be too complex and expensive and, therefore, has not been implemented.

A compromise on the video-on-demand concept has been proposed by Replay Networks, Inc. (USA) whereby viewers create their own “replay channels” containing content categorized by, for example, show titles, actor, movie type, etc., with such programming being recorded on hard disks at a local facility and later available for on-demand access by individual viewers.

Another type of on-demand video distribution system is described in U.S. Pat. No. 5,832,287, whereby video-on-demand and network programming is provided from master file and network program databases through multiple community systems, each of which may serve up to approximately one hundred homes.

Both the Replay Networks, Inc. and the '287 systems have severe limitations in terms of storage capability and customer options.

An interactive viewing system that automatically records selected programs is disclosed in U.S. Pat. No. 5,805,763. However, the '763 system simply provides another mechanism for recording television programs. This system attempts to simplify the VCR recording function, but because of its complex nature and limited benefits it has not been implemented.

There is an acute need in the video distribution industry for a system that will provide each individual viewer with ready access to tens of thousands of movies titles, as well as educational programming, network programming, audio programming and the like, in a convenient low-cost manner that fully satisfies user demand, while enhancing the economic incentives of content providers to create and distribute an ever expanding offering of movies and other video/audio content.

### SUMMARY OF THE INVENTION

The present invention provides a video distribution system that is beneficial to all involved parties, namely consumers, content providers and data transmission providers. In preferred embodiments, consumers are able to preselect movies for viewing from as many as eight thousand movies or more that are transmitted daily and as many as sixty thousand movies or more transmitted monthly. Customers of the video distribution system utilize a menu driven, graphical user interface with simplified controls that provide movie selection by title, type, category (e.g., comedy new releases from major studios). Video/audio content is transmitted via direct broadcast satellite (DBS) in an encoded VHS resolution format directly to each customer's receiving dish or antenna which is linked to the customer's user station where it is stored on a DVD RAM disc in a multiple disc platter. The movies may then be played at any time desired by the consumer, with the consumer paying for only those movies that are viewed. The movies are encoded to prevent conversion and duplication for play on existing DVD systems. The encoding technology also prevents playback on user stations of the video distribution system in homes that are not current on payments for previous purchases. The encoding system includes a novel time-based encoding technology.

The video distribution system of the present invention offers numerous advantages to consumers. For example, consumers have access to new movie releases at those times dictated by market conditions to be most favorable by the content providers and the distributors, often before the movies would be available at video rental stores. Consumers will pay for a movie only after it has been viewed, not when recorded. Thus, consumers are free to record categories or classes of movies (e.g., new releases) and later make a decision as to which movies to actually view—paying only for those that are viewed. Consumers may view the videos at any time without restraints related to broadcasting schedules and with no need to visit a video rental store for selection of the movie or returning the movie. There are no late fees. New movie releases will never be “sold out” as they frequently are in existing video rental stores. Another advantage to consumers is the ultimate lower cost occasioned by the system's elimination of the real estate and labor costs associated with existing video rental stores. Because literally thousands of movies are available on a daily/weekly/monthly basis, the video distribution system of the invention provides a much greater selection than any existing video rental store. The invention also provides full access to content for those who live in geographically remote and/or sparsely populated areas that may presently have little or no access to video rental stores. The invention also allows access to videos for families with young children, elderly persons and handicapped persons where theater viewing and round trips to video rental stores are inconvenient, prohibitive or expensive. Each user station utilizes high capacity storage such as DVD RAM for its read/write functions in addition to an operating system that provides greatly simplified on-screen programming. The present invention also provides the ability to update movie pricing at any time, for example on a daily, weekly or monthly basis, so that consumers can choose to view movies at times when content providers offer pricing specials or incentives. When a movie is recorded on a disc, it can be labeled and stored for future play or recorded over (similar to a blank VCR tape). As new movies are recorded and shelved, new or previously used videos can be inserted into the platter for future recording. Video quality is improved over existing video rentals where, in most cases, available tapes have been degraded by previous play.

Content providers (e.g., major studio producers) recognize a very significant benefit in that they receive income every time a movie is played, thereby creating significant residual value for their investments. Importantly, new release movies are always available (i.e., not “sold out”) during initial peak demand when pricing power is the highest. The mentioned residual value translates into increased income for the content providers because a significant portion of existing content is available for sale every day—since thousands of movies are transmitted on a daily/weekly/monthly basis. The invention also allows content providers to change pricing at any time, e.g., daily/weekly/monthly, to optimize price vs. consumer demand. In this regard, content providers are allowed to meet consumer demand for a significant portion of the existing content inventory value every day. This provides an extremely high benefit by effectively allowing the market to clear (i.e., real demand matches supply), something that the current video distribution model (TV, movie channels, pay-per-view and video rental) do not provide.

According to the invention, content providers are confident that they can distribute their movies with extremely high security through the use of appropriate encoding technology. Preferably, the encoding includes time-based encoding technology, with new code keys for every distributed movie transmitted via phone/modem with billing queries every month. Time-based coding, in combination with a single standard proprietary operating system, allows the video distribution system operator to achieve the level of security demanded by content providers.

Transmission providers (DBS satellite system providers, in preferred embodiments) realize the advantage of a significantly increased income base for supporting their services and the utilization of lower cost, off-peak time for transmission of a significant portion of the movies.

In one aspect, the video distribution system of the present invention includes a data transmission system blanket transmitting a plurality of encoded movies to customer households. A user station is provided at each customer household, the user station including means permitting the customer household to preselect desired transmitted movies for recording. A receiver and associated recording device at each customer household is provided for recording preselected movies. A playback device permits each customer to play back those preselected, recorded movies that the customer desires to view. The video distribution system also includes a central controller system having a database for storing therein an address corresponding to each customer household, a communications link between each customer household and the central controller system to verify to the controller unit that a preselected, recorded movie has been played back for viewing and a billing system linked to the central controller system to bill customer households for only those preselected, recorded movies that are played back for viewing.

In another aspect, the invention may be defined as a method of distributing movies to customer households comprising the steps of blanket transmitting a plurality of movies to customer households, permitting each customer household to preselect and record desired movies, permitting each customer household to playback for viewing any preselected, recorded movie, communicating movie playback information from each customer household to a central controller, and billing customer households for only those preselected, recorded movies that are played back for viewing.

### BRIEF DESCRIPTION OF THE DRAWINGS

Some of the features of the invention having been stated, other features will appear as the description proceeds, when taken in connection with the accompanying drawings, in which

FIG. 1 is a schematic representation of a video distribution system of the present invention utilizing satellite downlink data transmission.

FIG. 2 illustrates further details of a user station shown in FIG. 1.

FIG. 2A is a view of the user station of FIG. 2 showing several optional features.

FIG. 3 shows a hand held infrared remote control for use in association with the user station.

FIG. 4 is a block diagram showing components of a representative user station of the invention.

FIGS. 5-7 show several screens that appear on the display when a customer reviews available movies, preselects movies for viewing and performs other associated functions using the interactive program guide.

FIG. 8 illustrates a Level I time-based coding format that provides enhanced security for the transmitted programming.

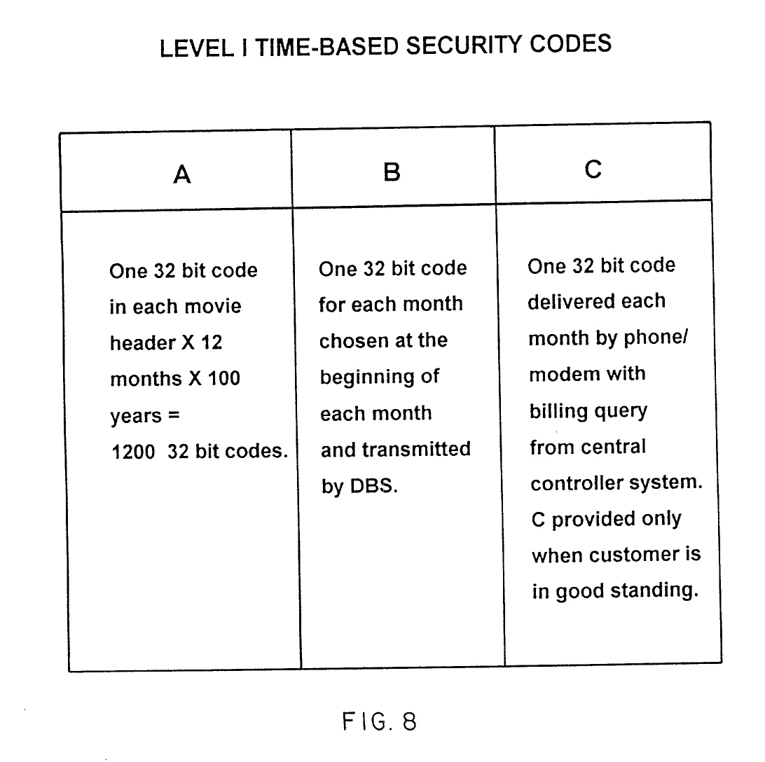

FIG. 9 is a block diagram showing functions of the central controller system.

FIG. 10 is a block diagram of one simplified embodiment of a business model for commercializing the video distribution system of the invention.

### DETAILED DESCRIPTION OF THE INVENTION

While the present invention will be described more fully hereinafter with reference to the accompanying drawings, in which aspects of the preferred manner of practicing the present invention are shown, it is to be understood at the outset of the description which follows that persons of skill in the appropriate arts may modify the invention herein described while still achieving the favorable results of this invention.

Accordingly, the description which follows is to be understood as being a broad, teaching disclosure directed to persons of skill in the appropriate arts, and not as limiting upon the present invention.

1. The Overall Video Distribution System, Generally

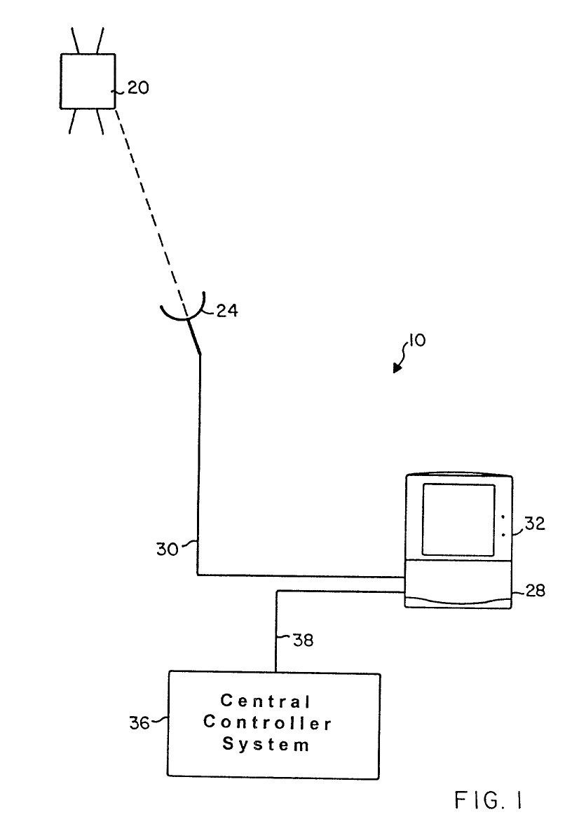

Referring to FIG. 1, there is shown a simple schematic of one embodiment of a video distribution system 10 of the invention. System 10 utilizes direct broadcast satellite (DBS) transmission via satellite 20 as the means for blanket transmitting encoded programming data, either in real time or in time compressed format (discussed below). The program data is received at each customer household by a receiving antenna or dish 24. Dish 24 is linked to a dedicated user station 28 by a satellite receiver link 30. User station 28 is an interactive device permitting customers to preselect desired transmitted movies, record the preselected movies and play back the recorded movies on a video display device (e.g., television 32) anytime the customer wishes to view them. Station 28 communicates at appropriate times with a central controller system 36 via a phone/modem connection 38 (land, Internet or cellular). Central controller system 36 stores a discrete address (e.g., telephone number, credit card number or billing address) for each customer household and receives information via connection 38 to verify that a preselected, recorded movie has been played back for viewing. Central controller system 36 utilizes the movie playback information to bill customer households and also to credit the accounts of content providers. The satellite link (or alternatively the central controller system 36) periodically communicates with each customer household to provide information on available movies and when they will be transmitted, along with pricing information for the playback of specific movies or categories of movies. In preferred embodiments, the satellite link and phone/modem connection 38 transmit time-based code keys for the transmitted movies that form part of the security system for the video distribution system.

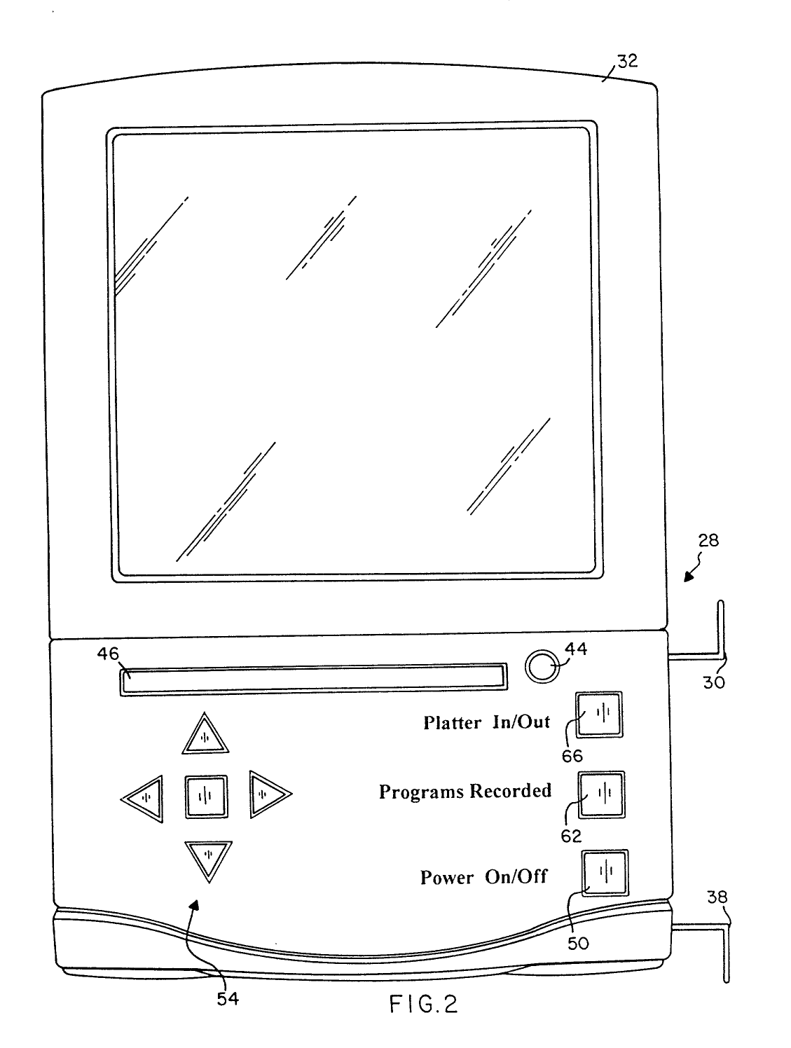

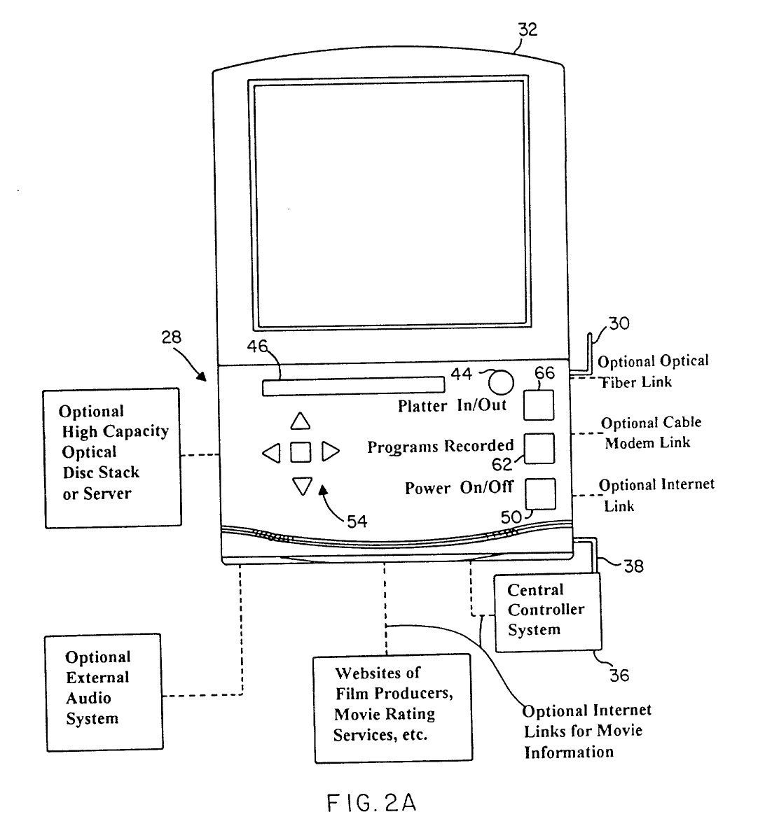

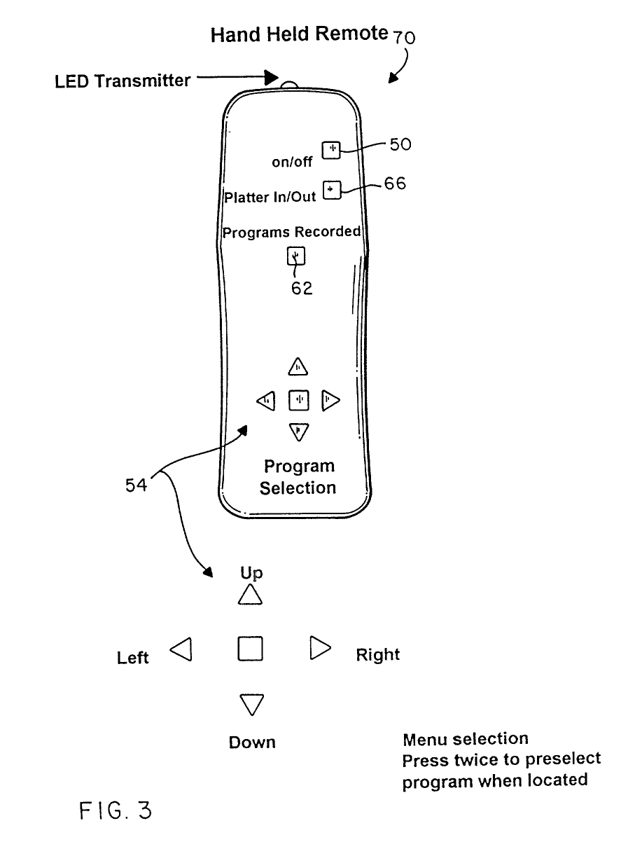

FIG. 2 illustrates the front panel of one embodiment of user station 28. Station 28 includes a port for the satellite receiver link 30, a phone/modem connection 38, a remote infrared sensor 44 and a DVD RAM platter 46 (e.g., a 10-disc platter) which is utilized as the write/read mechanism for recording and playback of movies or other content. User station 28 also includes a user interface comprising a power on/off switch 50, a five key program selector 54, a “Programs Recorded” key 62 and a platter out/in key 66, all of which preferably are duplicated on an infrared handheld remote 70 (FIG. 3). A more detailed discussion of the use of user station 28 to review movie availability, to preselect, record and playback movies will be set forth below in the description of the viewer interface and interactive program guide.

2. The Satellite(s)

According to preferred embodiments of the present invention, data transmission is achieved utilizing geostationary satellites operating in the KU band that are downlinked to conventional receiving antennae or dishes located at the customer households, which are in turn linked to TV Receive Only (TVRO) units connected the customer user stations.

Following the recent acquisition of PrimeStar's assets by Hughes, there are now two digital broadcast satellite providers in the United States, Hughes (DSS) and EchoStar (DISH Network). EchoStar's DISH network launched an additional satellite in September 1999 (its fifth satellite) that, in combination with its previous satellites, provides continuous transmission of greater than five hundred channels to substantially the entire continental United States. EchoStar now has satellites located in the 119, 110, 61.5 and 148 positions within the Clark Belt.

With the above satellite orientations, EchoStar's new “DISH 500” system utilizes an elliptical twenty inch antenna or dish containing two LMBS heads that can receive information from two different satellites simultaneously. As mentioned above, this system permits greater than five hundred channels to be directly broadcast to each customer household.

Currently preferred embodiments of the present invention utilize the EchoStar system, most preferably the DISH 500 system, for programming data transmission at either real time or time-compressed transmission rates, discussed below. In alternative embodiments, the invention may be implemented utilizing the Hughes (DSS) system, or a combination of both the Hughes and EchoStar systems (resulting in a relatively smaller portion of each system's total capacity being devoted to the invention's video distribution).

3. Data Transmission Parameters

EchoStar's DISH 500 system has 480×704 resolution, providing a very high band width of approximately 4 megabits/sec for each channel, for a total transmission capacity of approximately 2000 megabits/sec for five hundred channels.

As mentioned above, in accordance with certain preferred embodiments of the invention the video content (e.g., movies) may be broadcast at standard VHS resolution (240×352) which translates into a requirement of approximately 1.3 megabits/sec per channel with MPEG II compression. Thus, the full (greater than 2000 megabits/sec) capability of the DISH 500 system translates into the capability to broadcast approximately 1,530 movies simultaneously in real time (i.e., not time compressed). At 110 minutes per movie, the full twenty-four hour capacity is approximately 20,000 movies per day, far greater than total requirements for the video distribution system of the invention.

Thus, according to this aspect of the invention, a portion of the total transmission capability of the DISH 500 system may be utilized to blanket transmit thousands of movies for preselection and recording by customers. In this regard, and as discussed in more detail in the Examples below, new release movies (e.g., the 100 most popular new release movies from major studios) may be transmitted several times per day with concentration before and during prime evening viewing periods, with a second tier of popular movies transmitted less often, but still at least daily, and third and fourth tiers of movies transmitted weekly/monthly—all in accordance with content listings and transmission schedules available to customers through their periodically updated electronic program guide.

It will be appreciated that instead of using more typical 120 watt DBS transponders, implementation of the present invention may be carried out with higher power transponders (e.g., 240 watt transponders) to increase the effective transponder capacity (e.g., from 23 megabits/sec to 30 megabits/sec) by reducing much of the capacity allotted for forward error correction and system management inherent in lower power transponders. Also, along with the use of higher power transponders, the invention may be carried out with quanternary (QPSK) polarization to double the effective bit transfer rate for each transponder over that which may be obtained by using current orthogonal polarization—with a sacrifice in bit error rate that is acceptable for those applications of the invention where lower video and audio resolution is not an important consideration to the customer. Thus, the use of high power transponders (e.g., 240 watts or higher) in conjunction with higher level polarization (e.g., quanternary) permits video distribution systems of the invention to be implemented utilizing less of the DBS system's total transmission capacity, permits the transmission of a greater number of movies or other content, permits more frequent transmission of high demand (e.g., Tier 1) movies and permits greater time compression of movies, or a combination of the above, all to the benefit of consumers.

4. User Station Details

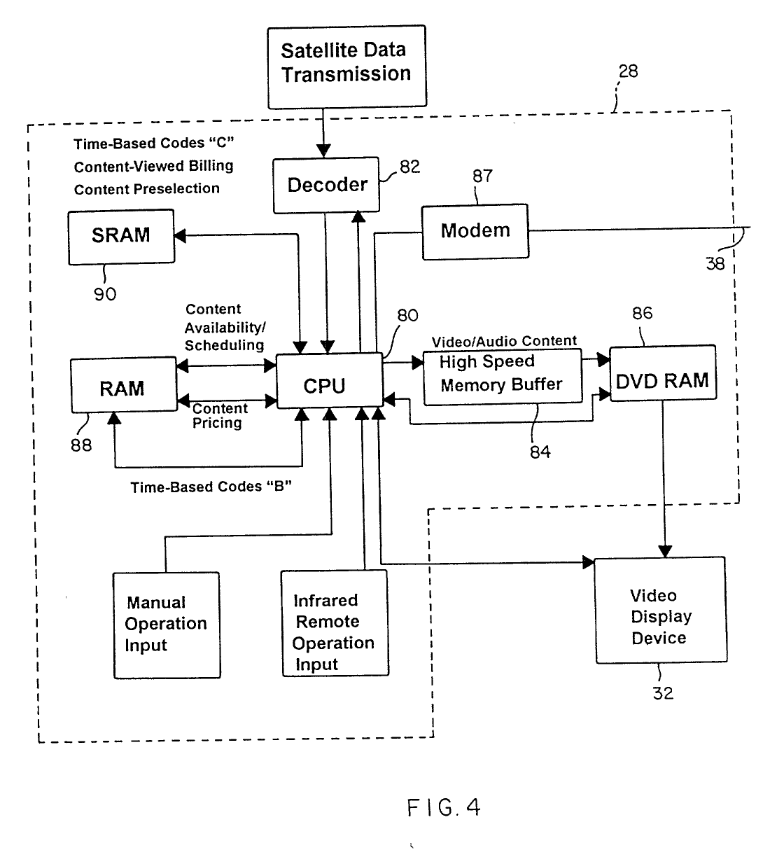

FIG. 4 is a block diagram showing components of a 20 representative user station 28 of the invention. The primary controller for station 28 is a central processing unit (CPU) 80 that includes a microprocessor, a non-volatile high speed memory device containing the unit's proprietary operating system, a graphics generator, and additional peripheral devices such as a clock that are common in CPU devices.

Encoded programming data via satellite downlink through antenna 24 is transmitted to a decoder 82. Decoder 82 looks for headers indicating movies or other content that have been preselected for recording. The programming data includes video/audio content data, content availability/scheduling data and content pricing data. Decoded preselected movie data is transmitted via CPU 80 to a high speed memory buffer 84 (with or without high capacity storage capability) and then written to a DVD RAM disc 86 that is associated with the DVD RAM platter 46. In certain embodiments, the high speed memory buffer 84 may utilize a magnetic drive, a magneto-optical drive, an optical drive, or other suitable drive. Buffer 84 may utilize DRAM, flash memory, SRAM or other suitable memory such as digital tape.

As will be appreciated by those skilled in the art, in alternative embodiments the transmitted data may bypass CPU 80.

An internal or external modem 87 connects to a phone line that provides communication to the central controller system 36.

The content availability/scheduling data, content pricing data and time-based security codes B (discussed below) are transmitted at periodic intervals (e.g., every ten minutes, every hour or every day, as deemed most desirable by the video distribution system operator) and are routed from CPU 82 to RAM 88 where the information is stored and available.

Viewed-content information used for billing purposes, content preselection information entered by the user and time-based security key codes C (discussed below) are stored and available in SRAM 90.

CPU 80 directly receives manual and infrared remote operation input data. The video display device 32 receives input from the DVD RAM platter for playback of movies and receives graphics data from CPU 80 for display of the interactive program guide.

It is understood that important aspects of this invention may be provided by different electronics configurations such as a central server to support, and in certain cases to replace, functions carried out by the RAM, SRAM and DVD RAM shown in FIG. 4. In addition, SRAM or a suitable high speed memory drive could be used to fulfill the function provided by the RAM (shown in FIG. 4). Other embodiments may include an additional disc drive in support of the system data storage and retrieval functions.

5. Viewer Interface/Interactive Program Guide

The viewer interface and interactive program guide will now be described in connection with how they permit a customer to review available movies, preselect movies for recording, playback movies for viewing and perform other associated functions.

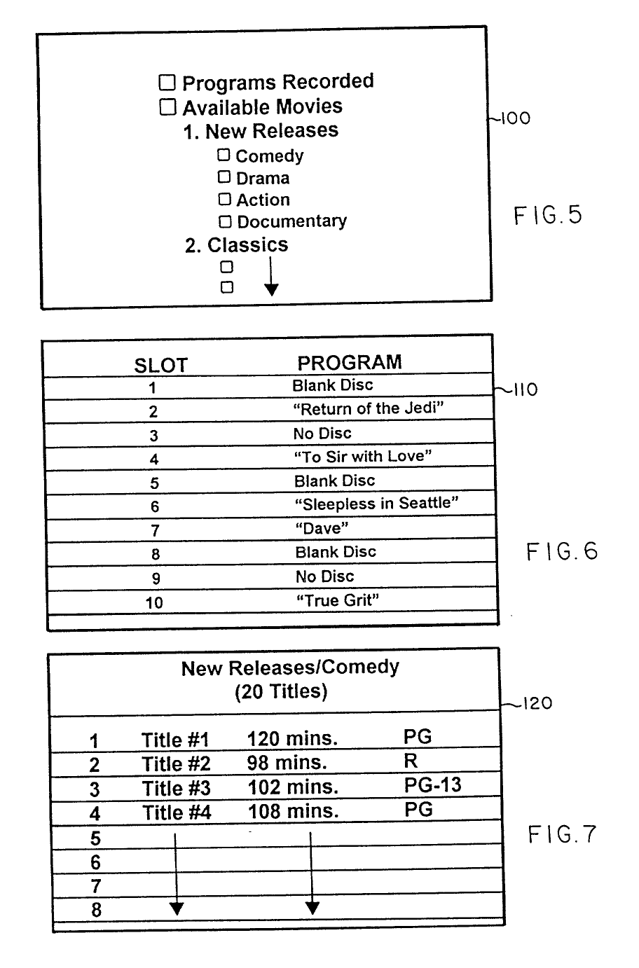

Referring to FIG. 5, there is shown a representative screen 100 that is displayed on the video display device 32 when a user initiates use of the system via on/off key 50. By utilizing the four (up/down, left/right) keys of the program selector 54 and by clicking on “Programs Recorded”, the user may choose to first determine the status of the multiple (e.g., ten) disc positions in the DVD RAM platter, i.e., what movies are currently recorded and stored in the DVD RAM platter at which disc positions, which disc positions contain blank discs and which disc positions have no discs. FIG. 6 shows a representative screen 110 indicating the status of each disc position. Once this information is displayed, the user may elect to playback a movie that is already on the platter, remove disc(s) for storage, etc.

After, or instead of, using the “Programs Recorded” function, the user may use the “Available Movies” function to scroll down through a listing of movies in the interactive program guide that, as shown, may be based on various categories of available movies. For example, the first category of movies is new releases, which may be subdivided into, for example, comedy, action, drama, documentary, etc. After a particular category of movies is chosen (e.g., new releases/comedy) another screen 110 (FIG. 7) is displayed showing the titles (in this case twenty titles) in this category. In order to preselect a title for recording, the cursor is moved to the chosen title and the middle key of program selector 54 is pressed twice, the first press showing the current playback price and changing the background color of the display (indicating “selection mode”) and the second press completing the selection.

It will be appreciated that the interactive program guide may include links to a short summary of a movie being considered, critical review(s) of the movie or a brief “clip” or preview of the movie. This information may be stored in internal memory, obtained through a link to the website of the video distribution system operator or obtained by direct Internet access to the websites of film producers, movie rating services, etc. (See FIG. 2A.) Other suitable means for providing movie information may also be employed.

6. Program Security Utilizing Encoding Technology

As mentioned above, in certain embodiments of the invention programming security is best achieved by time-based coding, in combination with the utilization of security codes that are interlaced into the video frames.

The proprietary operating system utilizes standard interlaced encoding data that, as known in the art, prevents movies recorded by a customer at a user station from being played on other nonconforming playback devices (for example, standard DVD playback devices). In addition, recognizing the possibility of pirates utilizing data conversion technology to defeat this security technique so that bootleg copies could be run on other systems, and recognizing the prospect of recorded movies being played on user stations that are not current on payment or are otherwise unauthorized, the invention incorporates a time-based code key to assure that playback of recorded content can only occur on currently authorized user stations.

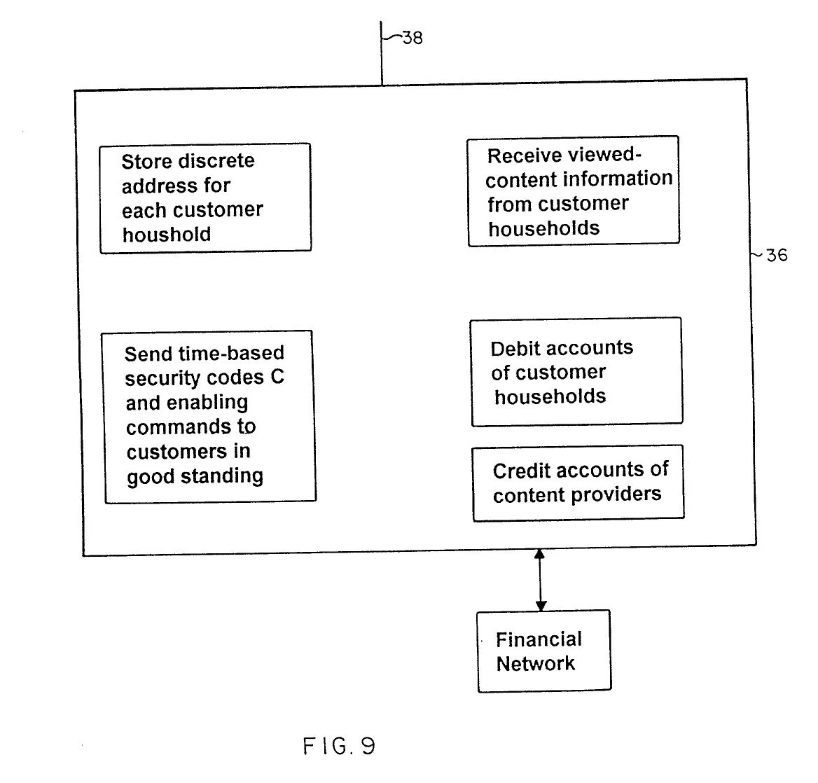

FIG. 9 describes one preferred Level I time-based coding format wherein a first code key A comprises a 32-bit monthly code at the beginning of each transmitted movie. With one such code key provided for each month over an extended period of time, say 100 years, there is a total of 12×100 =1200 32-bit code keys A per movie.

A second code key B comprises a 32-bit code for each month chosen by the video distribution system operator at the beginning of each month. Code keys B for all available movies are blanket transmitted to customer households each month by the data transmission means, preferably, satellite.

A third code key C comprises another 32-bit code for each available movie. Code keys C are delivered to each customer household by phone/modem on a monthly basis, preferably at the time of monthly billing queries from the central controller system 36 to the household. The third code keys C are provided only when the customer household is current in payments and otherwise is in good standing.

The time-based coding of FIG. 9 assures that a movie will playback at a specific user station only when all three code keys A (transmitted with the movie), B (chosen and blanket transmitted monthly) and C (delivered monthly by phone modem) are present, with the user station software simply verifying that C is the correct value when a predetermined mathematical function is applied to A and B.

Level II security coding comprises a 128-bit code interlaced through every third frame of the movie. This code, in conjunction with the decoding software of the unit's proprietary operating system, is used to assure that recorded movies can be played only on stations provided to consumers by the video distribution system operator. (The players incorporated into the proprietary user stations of the video distribution system simply read and ignore Level II code.) Thus, recorded movies may not be played back on standard DVD players. However, even if a determined pirate were to defeat the Level II code to produce a disc playable on a standard DVD player, a pirated copy would be useful only until the end of the month, due to Level I time-based coding protection, discussed above.

Optional Level III coding may be utilized to relate Level I and Level II coding in a specific location in each movie over multiple frames where the Level II code is a more complex (e.g., 1024K) program requiring completion from the time-based coding of Level I.

In addition to the security means discussed above, preferably each user station 28 must be in an enabled state. In this regard, an enabling command from central controller system 36 (via phone/modem) may be sent monthly to each customer household that is in good standing.

As an alternative to monthly billing queries by the central controller system 36 to each customer household, monthly provision of code keys C and monthly provision of an enabling command to customer households in good standing, as described above, these functions may be carried out each time a movie is played back for viewing via a two-way communication between central controller system 36 and the customer household. To this end, when a customer initiates playback of a movie through the interactive controls, the playback information (the identity of the movie and the identity of the customer household) is communicated to central controller system 36 by phone/modem, at which time central controller system 36 verifies good standing status for the customer household and sends back a single code key C for the specific movie and an enabling code for the user station. Utilization of this form of communication between a user station and central controller system 36 at the time of every playback offers the advantage of the video distribution system operator not having to send thousands of key codes C (for all available movies) on a monthly basis to each customer household (where the key codes C must be stored in memory) and the further advantage of assuring good standing of the customer household's account prior to each movie playback. A further advantage is that customers' accounts may be billed more currently, at the time of each playback instead of monthly.

7. Central Controller System

Referring to FIG. 9, the central controller system 36 will now be discussed in more detail. As discussed above, in one preferred embodiment central controller system 36 provides the following functions:

a. Stores a discrete address for each customer household.

b. Transmits monthly billing query to each customer household to determine which preselected, recorded movies were viewed.

c. Sends monthly transmission of time-based security codes “C” and an enabling command to each customer household that is current in its payments and otherwise is in good standing.

d. Credits accounts of content providers for the use of their content through linkage to a financial network.

e. Debits accounts of customers for movies viewed.

8. Alternative Data Transmission Technologies

Referring to FIG. 2A, several alternative data transmission technologies may be utilized in place of or in addition to direct broadcast satellite (DBS) which is discussed above.

A first option is data transmission by optical fiber employing suitable technology, preferably an optical fiber technology providing high transmission rates, for example OC3. A single OC3 optical cable transmits data at approximately 128 megabits/sec so that, at VHS resolution, it can transmit approximately sixty movies simultaneously at real speed, or transmit one movie every two minutes at a time-compressed speed.

Other options include cable/modem transmission, Internet connection, other suitable phone connections, or the use of higher or lower frequencies than KU if licensed for satellite-based content transmission, or a combination of any of the transmission means discussed herein.

It will be appreciated that video/audio content transmitted by any of the above means, whether transmitted at real time or at a time-compressed speed, may run in series for simultaneous recording on multiple stations at a consumer household.

9. Business Models

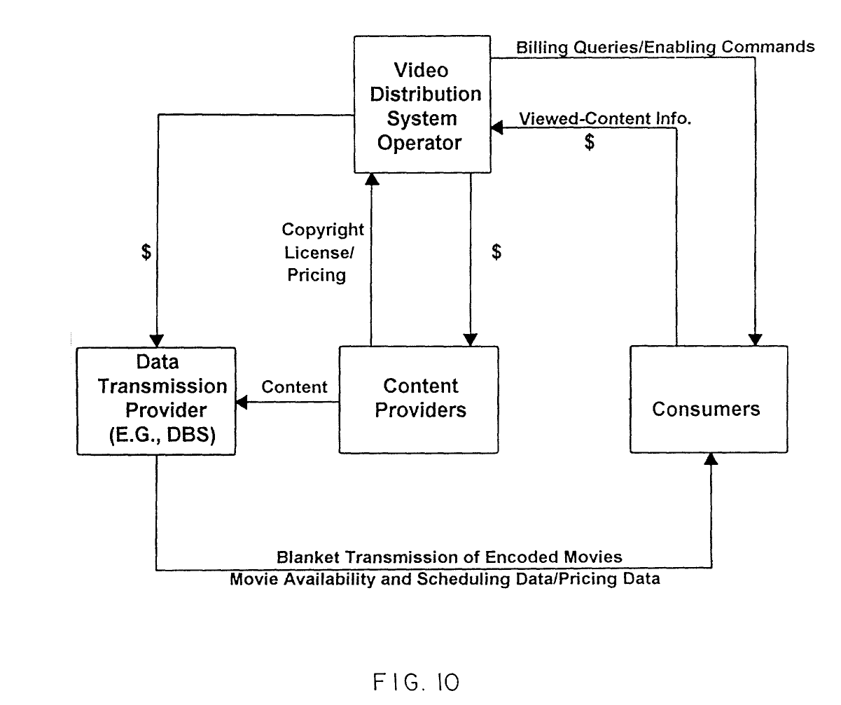

The present invention provides significant flexibility with respect to the business model to be used to commercialize the invention. In one simplified embodiment, shown in block diagram form in FIG. 10, the video distribution system operator interfaces with three parties, the data transmission provider, the content providers, and consumers. The content providers provide content to the data transmission provider which, in turn, blanket transmits the content to the consumers, preferably by direct broadcast satellite. The satellite transmission also includes content availability/scheduling data and content pricing data, updated periodically. The content providers also provide copyright license and pricing requirements to the video distribution system operator. Both the data transmission provider and the content providers receive payments directly from the video distribution system operator. Lastly, the video distribution system operator periodically receives viewed-content information for billing, while also sending enabling commands to the consumers.

Other business models may utilize time-based security coding as discussed above. Also, the Internet may be used to provide centrally posted content availability information and permit preselection of movies for recording at the customer's household.

### EXAMPLE I

The video distribution system of the present invention is implemented using the business model of FIG. 10, the DISH 500 DBS system, and the other hardware and software systems described above and illustrated in the drawing figures.

The video/audio content provided by the video distribution system is transmitted in real time (i.e., not time-compressed—average movie 110 minutes). The movies are blanket broadcast utilizing approximately 49% of the total capacity of the DISH 500 system, with transmission times heavily weighted for Tier 2, 3 and 4 movies to off-peak broadcast hours (e.g., 1:00 am-8:00 am).

Movie “Hierarchy”

Tier 1: The current 100 new release movies from major studios.

Tier 2: The 6000 movies that are at the second level of consumer demand after the Tier 1 new release movies.

Tier 3: The 8000 movies at the third level of consumer demand.

Tier 4: 60,000 additional movies.

Transmission Schedule

Tier 1: Each new release movie is transmitted every day on the hour from 4:30 pm to 8:30 pm, and at several other times daily.

Tier 2: Each Tier 2 movie is transmitted once per day.

Tier 3: Each Tier 3 movie is transmitted once per week.

Tier 4: Each Tier 4 movie is transmitted once per month.

A consumer who wishes to plan ahead can easily record all new releases in the “comedy” category, for example, and have them available for viewing at his pleasure, with payment obligations arising only for those movies he actually views, when he views them. The same consumer or another consumer wishing to view a new release on the evening at which the viewing decision is made, simply preselects the movie for recording any time during the day so that it will be available during the evening viewing hours. An Internet phone/modem connection (not shown) may be provided so that consumers may access their user stations from remote locations (e.g., from their business offices) to preselect movies for viewing that evening.

The term “movies” as used in connection with the Examples, and as used at other times herein, encompasses more than the term traditionally implies. The term “movies” may encompass not only motion pictures and similar content, but also certain content that appears in the lower tiers, especially Tier 4, such as classic sporting events (e.g., all Super Bowls) and popular TV series (e.g., all episodes of Star Trek or Sienfeld or I Love Lucy). In this regard, a customer who wishes to do so may record all episodes of I Love Lucy (transmitted monthly in Tier 4) on a multiple disc platter, store the discs and playback selected episodes any time he desires, paying only when he views an episode or episodes.

### EXAMPLE II

The video distribution system of Example II is implemented with the same tiers of movies as Example I with the difference being that the Tier 1 movies are transmitted in compressed time format to a high speed memory buffer contained in the user station which, in turn, writes to the DVD RAM disc at its maximum write speed. This compressed time transmission (e.g., 8 to 10 minutes per movie) permits consumers to have movies, particularly Tier 1 movies, available on short notice, often in a time less than or on the order of that time required for a round trip to a video rental store. To further facilitate this enhanced availability of movies on short notice, according to Example II Tier 1 new release movies are transmitted every 30 minutes from 5:30 pm to 8:30 pm, and at several other times daily.

### EXAMPLE III

Same as Example II except that all movies are transmitted in compressed time format.

### EXAMPLE IV

The video distribution system of this Example IV is implemented with the same tiers of movies as Examples I-III. According to Example IV, the recording and playback device of user station 28 comprises a magneto-optical disc recording and playback device that has the capacity to write to a magneto-optical disc at write speeds on the order of 12 megabits/sec or greater, a write speed that is approximately 8 to 10 times the data stream speed for conventional VHS resolution video/audio transmission and playback (with conventional MPEG II compression). Utilizing an approximately 12 megabit/sec write speed, and a corresponding data transmission speed via DBS or other suitable transmission means, a movie may be transmitted in time-compressed format and recorded at 8 to 10 times real time, so that a 110 minute movie may be transmitted and recorded in approximately 11 to 14 minutes or less.

In order to provide ready consumer access to new-release movies, each of the 100 Tier 1 movies is broadcast from 6:00 p.m. to 9:00 p.m., at 15 minute intervals. Thus, during these prime time hours, a consumer may select any Tier 1 movie and have it available for viewing within 15 to 30 minutes. (With faster transmission and write speeds the Tier 1 movie availability time period may be reduced accordingly.) As with Example II, the Tier 1 movies are also transmitted at several other times daily, for example, hourly.

According to Example IV, Tier 2, 3 and 4 movies are also transmitted and written to discs in compressed time, for example, at approximately 12 megabits/sec or greater.

### EXAMPLE V

The distribution systems described in Examples I-IV have the capability to transmit audio in compact disc (CD) quality or another form to a suitable storage medium such as read/write CD's, write only CD's, DVD RAM, magneto-optical disc, digital tape or a central server. In this Example V, the consumer may choose any music selection from up to as many as 80,000 or more titles in a tiered transmission structure similar to Examples I-IV and use less than 10% of the existing DBS transmission capacity.

With music distribution under this Example V, the system allows the user to listen to the recording (e.g., CD) several times for free before the consumer is required to permanently select the CD. Once permanently selected, the CD receives a permanent enabling code and the consumer pays a one time fee—similar to the current one-time fee structure which is standard in the existing music distribution business model.

The player then plays the CD through TV speakers or provides an audio output to an optional external audio system (FIG. 2A).

This music distribution model eliminates a significant portion of the labor, real estate and transportation costs inherent in the current distribution models for music, much as the novel movie distribution model described herein eliminates costs in the distribution of movies as compared to current models. The music distribution model of this Example V may utilize DBS or the alternative data transmission means described above, either alone or in combination.

### EXAMPLE VI

The distribution system of Example IV is augmented with CD quality music transmission capability where 10,000 titles per day are transmitted at a time-compressed speed of, for example, 12 megabits/sec or greater. The music transmission of this Example VI may be carried out by utilizing additional DBS capacity, by reducing the number of Tier 2 movies transmitted daily, by reducing movie transmission in other tiers, or by a combination of the above. As described above in connection with Example V, the customer may listen to the recording several times for free after the encoded transmission is stored (with or without the use of memory buffer 84), before the purchase selection. Once the purchase selection is made, the recording preferably is written to a conventional CD so that it may be played back on conventional home or auto playback devices. To this end, the user station 28 may include positions for holding and writing to conventional CD's—in addition to the ability to write to another medium such as DVD RAM or magneto-optical discs used for storage of movies. In the alternative, once the recording is selected, it may be routed to the external audio system (FIG. 2A) which has its own CD read/write or write only device that will permanently write the selected recording to a CD that can be held in a single, stack or platter system.

While the present invention has been described in connection with certain illustrated embodiments, it will be appreciated that modifications may be made without departing from the true spirit and scope of the invention. For example, the term “video display device” has been used herein in its broadest sense to refer to any suitable video imaging system, such as a television, computer monitor, plasma screen, LED display, liquid crystal display, 3D imaging system, or the like, understanding that an appropriate audio capability is provided.

Also, while a DVD RAM platter system has been described as one preferred recording and playback device, both at real time and time-compressed transmission speeds and write speeds to the discs, other systems may be used, alone or in combination, such as magneto-optical disc, digital tape, VHS tape, a central or auxiliary server (optical, magnetic or magneto-optical). The discrete storage media of any one of these alternative devices may be arranged in a platter or stack or other suitable format to provide the user access to multiple stored audio/video content stored thereon. These and other modifications are deemed to be within the true spirit and scope of the invention.

That which is claimed

1. A method of distributing movies and music to customer households comprising the steps of:
blanket transmitting a plurality of movies and music selections to customer households;
permitting each customer household to preselect and record desired movies and music selections;
permitting each customer household to playback for viewing any preselected, recorded movie;
communicating movie playback information and music selection recording information from each customer household to a central controller system; and
billing customer households for music selections that are recorded and for only those preselected, recorded movies that are actually played back for viewing.

2. The method of claim 1 including the step of encoding the transmitted movies with data permitting playback only on a playback device with compatible decoding means.

3. The method of claim 1 wherein the customer household records music selections on conventional compact discs (CD's) so that the recordings may be played back on conventional home or auto CD playback devices.

4. The method of claim 1 including the step of utilizing the movie playback information and music selection recording information communicated to the controller system to credit the accounts of the content providers who provide movies for distribution and the music licensors who provide music selections for distribution.

5. The method of claim 1 wherein the step of blanket transmitting movies and music to customer households is carried out by a transmission mode selected from the group consisting of direct broadcast satellite, optical fiber, cable modem and the Internet.

6. The method of claim 1 wherein the step of blanket transmitting is carried out by direct broadcast satellite transmission on multiple channels.

7. The method of claim 1 wherein the step of blanket transmitting is carried out by transmitting at least a portion of the movies in compressed-time format.

8. The method of claim 7 wherein the transmission in compressed-time format is carried out by a data transmission means selected from the group consisting of direct broadcast satellite, optical fiber, cable modem, or combination thereof.

9. The method of claim 7 wherein the customer household records movies that are transmitted in compressed-time format at a write speed faster than real time.

10. The method of claim 9 wherein both the compressed time transmission and write speeds are eight to ten times real time or faster.

11. The method of claim 7 wherein the movies transmitted in compressed-time format are transmitted and recorded in the customer household at a resolution on the order of VHS resolution.

12. The method of claim 7 wherein the movies transmitted in compressed-time format are recorded in the customer household on a magneto-optical device at a write speed on the order of 12 megabits/sec or greater.

13. A method of distributing movies and music to customer households comprising the steps of:
blanket transmitting a plurality of movies and music selections to customer households;
at each customer household, preselecting desired transmitted movies and music selections for recording;
at each customer household, recording preselected movies and music selections when they are transmitted;
at each customer household, playing back those preselected, recorded movies that the customer household desires to view;
providing a central controller system having a database for storing therein an address corresponding to each customer household;
communicating information from each customer household to the controller system to verify when a preselected music selection has been recorded and when a preselected, recorded movie has been played back for viewing; and
using the communicated information to charge each customer household when it records a music selection and when it views a preselected, recorded movie.

14. A system for distributing movies to customer households, comprising:
means for blanket transmitting a plurality of movies and music selections to customer households;
means permitting each customer household to preselect and record desired movies and music selections;
means permitting each customer household to playback for viewing any preselected, recorded movie;
means for communicating movie playback information and music selection recording information from each customer household to a central controller system; and
means for billing customer households for music selections that are recorded and for only those preselected, recorded movies that are actually played back for viewing.

15. A system for distributing movies to customer households, comprising:
a direct broadcast satellite (DBS) data transmission system blanket transmitting a plurality of encoded movies to customer households at a data transmission rate faster than real time;
a user station at each customer household, the user station including means permitting the customer household to preselect desired transmitted movies for recording;
a receiver and associated recording device at each customer household for recording preselected movies at a write speed faster than real time;
a playback device at each customer household for playing back those preselected, recorded movies that the customer household desires to view;
a central controller system having a database for storing therein an address corresponding to each customer household;
a communications link between each customer household and the central controller system to verify to the controller system that a preselected, recorded movie has been played back for viewing; and
a billing system associated with the central controller system to bill customer households for only those preselected, recorded movies that are played back for viewing.

16. The system of claim 15 wherein the recording device at the customer household has a write speed capability on the order of 12 megabits/sec or greater.

17. The system of claim 16 wherein the recording device at the customer household comprises a magneto-optical device.

18. The system of claim 15 wherein the recording device at the customer household has a write speed capable of recording movies at VHS resolution at eight to ten times real time or faster.

19. The system of claim 15 wherein during prime time viewing hours at least certain high demand movies are each transmitted at short intervals at eight to ten times real time or faster, so that a high demand movie may be available for viewing within no more than the interval time plus a transmission/recording time on the order of 11 to 14 minutes or less.

20. The system of claim 15 wherein the user station includes a memory buffer for processing preselected movie data before it is recorded at the customer household.

21. The system of claim 20 wherein the memory buffer includes a drive selected from the group consisting of magnetic drive, optical drive and magneto-optical drive.

22. The system of claim 20 wherein the memory buffer includes memory means selected from the group consisting of DRAM, flash memory, SRAM and digital tape.

23. A system for distributing movies and music to customer households, comprising:
a data transmission system blanket transmitting a plurality of music selections and encoded movies to customer households;
a user station at each customer household, the user station including means permitting the customer household to preselect desired transmitted movies and music selections for recording;
a receiver and associated recording means at each customer household for recording preselected movies and music selections;
a playback device at each customer household for playing back those preselected, recorded movies that the customer household desires to view;
a central controller system having a database for storing therein an address corresponding to each customer household;
a communications link between each customer household and the central controller system to verify to the controller system when a preselected music selection has been recorded and when a preselected, recorded movie has been played back for viewing; and
a billing system associated with the central controller system to bill customer households for music selections that are recorded and for only those preselected, recorded movies that are played back for viewing.

24. A method of distributing music to customer households comprising the steps of:
blanket transmitting a plurality of music selections to customer households by direct broadcast satellite (DBS) at data transmission rates faster than real time;
providing each customer household with information identifying available music selections that will be transmitted;
permitting each customer household to preselect and record desired music selections in conventional compact disc (CD) format;
permitting each customer household to permanently select recorded music selections that the customer wishes to maintain for unrestricted playback;
communicating permanent selection information from each customer household to a central controller system; and
billing customer households for the recorded music selections that are permanently selected.
